(19) United States
(12) Patent Application Publication
(10) Pub. No.: US 2005/0224158 A1
(43) Pub. Date: Oct. 13, 2005

(54) Bead construction method and apparatus for a tire

(76) Inventors: Christopher David Dyrlund, North Canton, OH (US); Gary Robert Burg, Massillon, OH (US); Brian Richard Koch, Hartville, OH (US); Dwayne Richard Huston, Fairlawn, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/815,568

(22) Filed: Apr. 1, 2004

(51) Int. Cl. B29D 30/48

(52) U.S. Cl. 156/117; 156/130.7; 156/135; 156/136; 156/397; 156/422; 152/539

(57) ABSTRACT

A method and apparatus for manufacturing an annular tire component such as a tire bead includes locating a toroidal support; placing an ejector nozzle in an interference relationship to the toroidal support; and simultaneously ejecting through the nozzle a continuous stream of an elastomeric belt component material in a suitably fluid state and a continuous length of at least one thread component disposed within the stream onto the toroidal support in a predetermined bead configuration. The bead configuration is at least partially defined by a relief in the nozzle ejection port and by the toroidal support onto which the bead is formed. Rotation of the toroidal support may be coupled with the simultaneous ejection of the elastomeric component and thread component in order to create an annular bead structure. A tire may be constructed having a desired bead configuration and location by means of the method and apparatus.

### FIELD OF THE INVENTION

The invention relates to method and apparatus for the construction of an annular component for a tire and, more specifically, to the construction of an annular bead component for a tire built upon a rotating toroidal mandrel.

### BACKGROUND OF THE INVENTION

It is known in the art to build a tire by sequentially laminating strips of tire component material to a rotating toroidal mandrel or core. The components applied to the mandrel in such a laminate fashion may include the tire bead comprising an annular tensile member wrapped by ply cords and shaped to fit the rim of rubber as a base. Some prior art exists wherein tire beads are built onto a rotating toroid by laminating strips of rubber as a base, followed by applying a single spiraled strand of wire/cable, a second layer of rubber, and so on until the appropriate number of bead strands are complete.

While a laminate method of building a tire on a toroidal mandrel is an improvement over alternative methods and has been widely accepted, several shortcomings to such an assembly process remain which prevents the method from representing a solution to all needs of the industry. First, a laminate assembly technique requires that each tire component, including the bead structure, be pre-made into solid strips. The strips are typically inventoried which further adds cost to the process. Storing the strips for a period of time may also cause a degradation in material performance characteristics and adversely affect the quality of a tire made therefrom. Moreover, the process of layering the pre-made bead strips onto a mandrel is laborious and relatively slow, adding cost to the manufactured product. Additionally, the placement and location of the cable(s) in a laminate process is not carefully controlled and the resultant bead structure may suffer from misalignment of the cable within the confines of inner and outer layers. The performance or quality of a tire suffering from cable misplacement may thus be compromised. In addition, the time demands in assembling a tire bead by means of sequentially laminating layers onto a mandrel pursuant to the prior art are considerable and add undesirably to the overall cost of tire manufacture.

### SUMMARY OF THE INVENTION

To be able to build up a tire component, such as a bead structure, consisting of an elastomeric component and a thread-like component (metal or other material), the subject invention simultaneously applies the two materials to a rotating toroidal support or mandrel. A nozzle, pressurized with elastomeric component material at an elevated temperature, is placed in an interference relationship with a rotatable toroid support. The nozzle, according to one aspect of the invention, is provided with a relief at the application point such that the profile of the rubber being applied to the toroid will be determined on multiple sides by the relief in the nozzle ejection point and on an additional side by the surface of the toroid. A second path through the same nozzle is used to run a strand or strands of a thread-like material such that the rubber and strand(s) are applied simultaneously, thereby building up the tire bead component. The ejected elastomeric component and thread component may be applied to a pre-applied elastomeric layer on the toroid. Pursuant to another aspect of the invention, a method is disclosed comprising the steps of placing an ejector nozzle in an interference position to a toroidal support or mandrel and placing and simultaneously ejecting through the nozzle a sufficiently elongate stream of the elastomeric component in a substantially semi-solid state and a sufficiently elongate length of at least one thread component disposed at a preferential location within the stream onto the toroid in a predetermined bead configuration. Pursuant to another aspect of the invention, a tire bead component is built sequentially onto a toroid support by the simultaneous ejection of elastomeric and cable components in the manner previously summarized.

### BRIEF DESCRIPTION OF THE DRAWINGS

The invention will be described by way of example and with reference to the accompanying drawings in which:

FIG. 1 is a perspective view shown partially in section of a toroidal support onto which an annular component is applied pursuant to the invention;

FIG. 2 is a cross sectional view of the toroidal support showing an ejector nozzle positioned in an interference relationship therewith;

FIG. 3 is an enlarged perspective view of an ejector nozzle configured pursuant to the invention; and

FIG. 4 is a front perspective view shown partially in cross-section of the ejector nozzle showing the relief configuration at the nozzle application point.

### DETAILED DESCRIPTION OF THE INVENTION

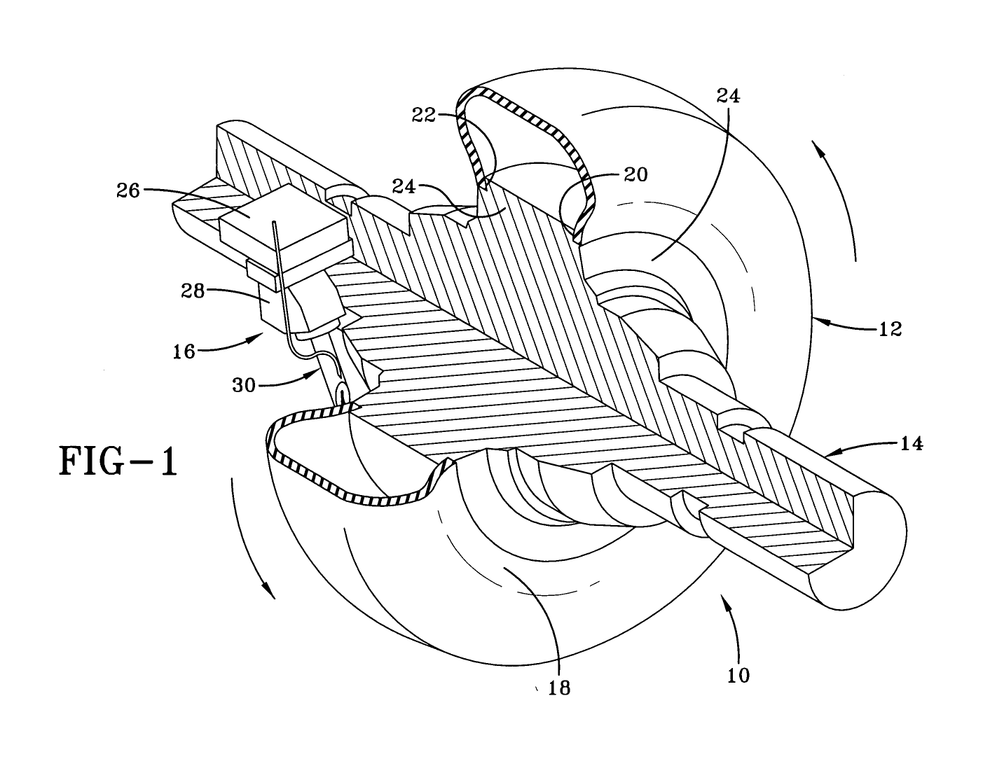

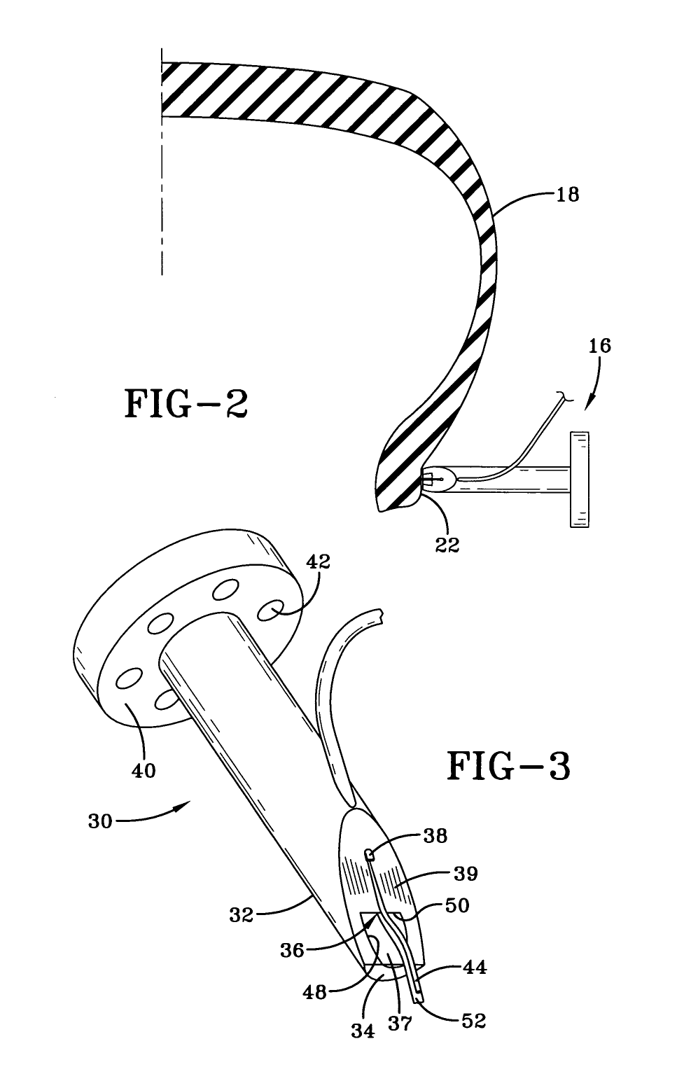

Referring initially to FIGS. 1 and 2, a tire building apparatus 10 is shown generally to include a rotatable toroidal support 12; an axial pivot drive shaft 14, and a bead component ejector assembly 16. The rotatable support 12, also referred herein as a mandrel, includes a toroidal tire shaping surface 18 coupled to a center hub 24 along annular edges 20, 22. The support 12 may be formed from any suitable material common to the industry such as steel. Support 12 may be of unitary, fixed geometrical construction or may comprise segments that collapse or otherwise move relatively to alter the geometry of the support during a tire build cycle. The drive shaft 14 is coupled to rotate the hub 24 and therefrom the annular surface 18 during a tire build. The surface 18 is configured to the shape of a tire to be built on the structure. It is contemplated that layers of elastomeric material such as rubber or a rubber composite will be applied to the surface 18 in a first stage of assembly to form a tire carcass. The carcass will normally include one or more plies, and a pair of sidewalls, a pair of apexes, an inner liner (for a tubeless tire), a pair of chafers and perhaps a pair of gum shoulder strips. Additional components may be used or even replace some of those mentioned above.

Typical tire building machines comprise a tire build drum around which the tire components are wrapped in successive layers including, for example, an inner liner, one or more carcass plies, optional sidewall stiffeners and bead area inserts (e.g., apex), sidewalls and bead wire rings (beads). After this layering, the carcass ply ends are wrapped around the beads, the tires are blown up into a toroidal shape, and the tread/belt package is applied. Typically the tire build drum is in a fixed location on the plant floor, and the various layers of components are applied manually or automatically using tooling registered to reference points on the fixed drum in order to ensure component placement with the desired degree of precision. The tooling is generally fixed relative to the tire building drum, for example a guide wheel on an arm extending from the same frame (machine base) which supports the tire building drum.

The subject invention is intended to provide a novel manner for building an annular component such as a tire bead onto the toroidal support 12. To facilitate the process the applicator assembly 16 is disposed adjacent to the rotating toroidal support 12 and, more specifically, adjacent surface 18 proximate an outer edge 22 thereof as illustrated in FIG. 2. The applicator assembly 16 comprises a mounting bracket 26 and an elastomeric component reservoir 28. As used herein, “elastomeric component” is preferably, but not necessarily, a rubber or rubber composite compound of a type common within the industry as a bead elastomer.

Referring to FIGS. 1, 2, and 3, the assembly 16 further includes an elongate ejector head assembly 30 comprising an elongate nozzle 32 extending to a forward tip 34. A first channel 36 has an opening 37 at the tip 34 and extends rearwardly along the longitudinal axis of the nozzle 32. The forward end of the nozzle includes a tapering surface 39 extending downward to the tip 34. A secondary cable channel 38 extends through a forward end of the nozzle 32 and exits at the sloping surface 39. A mounting annular collar flange 40 is disposed at a rearward end of nozzle 32 and includes a plurality of mounting apertures 42. The configuration and construction of the ejector head assembly 30 is intended to be representative of one of a plurality of alternative configurations that will be apparent to those skilled in the art. The invention is not intended to be limited to the shown location and dispensation of the channels that carry the elastomeric bead component and the cable component to an application end of an ejector assembly. Other configurations that provide for the requisite simultaneous application of an elastomeric and cable component to a targeted annular surface, as explained below, are also intended to be within the scope of the invention.

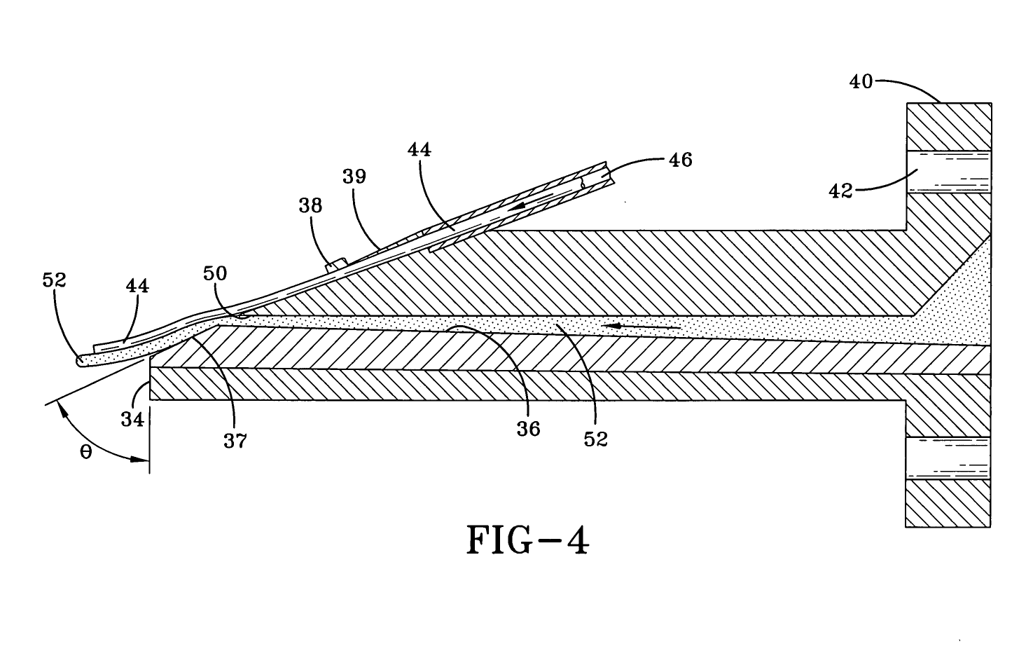

As best illustrated in FIG. 4, a cable 44 is provided that extends through the nozzle forward end to surface 39. The cable 44 is encased within a sheath or cavity 46 rearward of the forward nozzle end and extends therefrom to a cable supplying mechanism such as a spool (not shown) that feeds the cable axially forward to the forward end of nozzle 32 on demand. Cable 44 is constructed from suitable materials conventional to the industry in the construction of a bead cable such as, but not limited to steel. Cable 44 may comprise a single strand or a twisted construction of multiple strands if desired.

The forward end or tip 34 from which the elastomeric compound 52 exits the nozzle 32 as a stream is defined by a relief comprising opposing sidewalls 48 (one of which being shown in the section view FIG. 3) and inner end wall 50. The size and shape of the exit cavity or relief determines the sectional configuration of a stream of elastomeric compound exiting the nozzle 32. An angle 0 as shown in FIG. 4 is defined by the slope of the surface 39 and is preferably, but not necessarily, substantially sixty degrees. The relief angle affects application parameters such as flow characteristics and may be varied to adjust such parameters without departing from the invention.

It will be appreciated from FIGS. 1, 2, 3, and 4, the subject applicator assembly 16 intended for placement into an interference relationship with toroidal surface 18 of toroidal support body 12. As used herein, “interference” is meant a proximal relationship sufficiently close to the toroidal surface 18 such that material discharged from the nozzle will be placed at an intended location on surface 18. An “interference” relationship, therefore, may be but is not necessarily a contacting relationship between the nozzle and the surface 18. In the formation of an annular object, such as a tire, the annular support 12 may be rotated and components of the tire layered upon surface 18. Although it is preferable that the toroidal support 12 be rotated while the ejector assembly 16 is moved around the perimeter of the toroid to apply components as the toroid rotates, the practice of the invention is not intended to be so limited. In other configurations, the relative movement of the ejector system 16 and toroidal support may be alternately designed. Means for rotating the support drive shaft 14, the ejector assembly 16, and rotating support 12, are not shown. Suitable rotational drive motors and controls are commercially available and may be readily obtained for such a purpose.

In sequence, an annular bead structure may be constructed onto the support surface 18 pursuant to the invention by the simultaneous application of two materials to the rotating toroidal support. The two components comprise the elastomeric component 52 exiting as a stream from the relief opening in nozzle end 34 and a thread-like component, typically the cable 44 formed of metal or other material, exiting from the exit portal of the cable channel 38. As cable 44 exits from the cable channel 38 in a continuous manner, the cable 44 is disposed within the stream of elastomeric component material exiting from the relief exit cavity 37. The nozzle 32 is pressurized to a suitably high level and the elastomeric component material 52 is driven through the nozzle by conventional apparatus at a suitably elevated temperature to maintain the material 52 in a semi-solid state.

The nozzle ejects a stream of material 52 in a sectional profile determined by the configuration of the relief at the application point; the pressure exerted by the ejector assembly on the toroid; the rubber composite temperature and composition; and the nozzle pressure. The sectional profile of the rubber stream thus is determined on three sides by the sidewalls 48 and 50 of the relief and along a fourth side by the surface 18 of the rotating toroid support. Surface 18 thereby cooperates with the sidewall configuration of the relief to define the sectional shape of the rubber stream as the stream is applied under pressure in a semi-solid state to the rotating toroidal support. While the preferred embodiment recommends a stream of material 52 having a quadrilateral sectional profile, the invention envisions that the relief configuration at the tip of the nozzle may be varied if so desired into alternate configurations to create a stream of material having alternative sectional configurations.

The second channel through the same nozzle 32 is used to run a strand or strands 44 of the thread-like material of the bead. The feed of the cable 44 is directed into the stream of elastomeric component material 52 at an optimum location and the physical encasement of the cable within the stream in such a location ensures that the cable will be optimally located relative to the rotating toroidal support surface. A simultaneous application of the cable and elastomeric component layers thus achieves an efficiency of manufacture as well as an improved accuracy in the placement of the cable within the elastomeric rubber stream and subsequently against the rotating toroidal support. Moreover, the strand 44 may be cut and stopped, while rubber continues to be applied, or the strand 44 may be started into an already flowing stream of material 52.

It is envisioned that the elastomeric component material 52 will be supplied to the application point of the nozzle as a semi-solid, having a sufficiently low viscosity to retain a shape defined by the nozzle relief and the rotating toroid but a sufficiently high viscosity for controlled, pressurized ejection from the nozzle. The rubber material, once applied to the rotating toroidal support, fuses to the rubber-based tire components pre-positioned thereon. The application of a semi-solid bead elastomeric rubber to the pre-disposed tire layers upon the rotating toroid support establishes a positive bond. In addition, the cable(s) disposed within the rubber stream, being applied simultaneously with the rubber component, affords the additional advantage of holding the cable(s) 44 in place with the rubber 52 by essentially providing a coat layer on top or on all sides of the cable. The toroidal surface 18 is thus encircled by an annular bead formed by simultaneous application of the elastomeric component material and the cable component. Thereafter, the remaining tire components may be built to the annular support 12 and cured in a conventional manner to form a finished product.

While the subject invention finds particular application in the formation of a tire bead, other applications are possible. By way of example, without any intent to delimit the invention, the subject disclosure can also find general application in the creation of any elastomeric annular body, including but not limited to tire belts, spiral overlays, and ply components, wherein a portion of the annular body construction consists of a thread-like component ensheathed within an elastomeric component. A simultaneous application of such a thread-like component with an elastomeric component from a nozzle ejection system would, in such applications, prove beneficial.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A method of manufacturing an annular bead comprising an elastomeric component and at least one thread component for a tire comprising the steps of:
a. locating a toroidal support;
b. placing an applicator nozzle in an interference position to the toroidal support;
c. placing and at least for a period of time simultaneously applying through the nozzle a sufficiently elongate stream of the elastomeric component in a substantially semi-solid state and a sufficiently elongate length of the at least one thread component disposed within the stream onto the toroidal support in a predetermined bead configuration.

2. A method of manufacturing an annular bead according to claim 1, further comprising the step of pre-layering an elastomeric tire layer on the toroidal support.

3. A method of manufacturing an annular bead according to claim 2, further comprising the step of rotating the toroidal support during application of the elastomeric component and the at least one thread component from the nozzle.

4. The method of manufacturing an annular bead according to claim 1, further comprising the step of rotating the toriodal support and the elastomeric layer thereon simultaneously with application of the elastomeric and at least one thread component from the application nozzle.

5. The method of manufacturing an annular bead according to claim 1, further comprising the step of at least partially defining the predetermined bead configuration at an application point of the application nozzle by a relief in the nozzle.

6. The method of manufacturing an annular bead according to claim 5, further comprising the step of at least partially defining a side of the predetermined bead configuration by the toroidal support.

7. The method of manufacturing an annular bead according to claim 6, further comprising the step of defining at least three sides of the predetermined bead configuration by at least three sides of the relief in the nozzle and at least one side by the toroidal support.

8. The method of manufacturing an annular bead according to claim 1, further comprising the step of pressurizing the elastomeric component at an elevated temperature within the nozzle prior to application.

9. The method of manufacturing an annular bead according to claim 1, further comprising the steps of positioning the at least one thread at a preferred location within the stream and maintaining the at least one thread in the preferred location during a post-application curing of the elastomeric component.

10. The method of manufacturing an annular bead according to claim 9, wherein the preferred location of the at least one thread is substantially in the middle of the stream.

11. An apparatus for forming an annular bead for a tire of a type comprising an elastomeric component and at least one thread component, the apparatus comprising:
a. a toroidal support;
b. nozzle means disposed in an interference relationship with the toroidal support;
c. the nozzle means ejecting a sufficiently elongate stream of the elastomeric component in a substantially semi-solid state and a sufficiently elongate length of the at least one thread component disposed within the stream onto the toroid support in a predetermined bead configuration.

12. An apparatus according to claim 11 further comprising means for rotating the toroidal support relative to the nozzle means.

13. An apparatus according to claim 11 wherein the nozzle means includes a relief at an ejection portal for at least partially defining the predetermined bead configuration.

14. An apparatus according to claim 13 wherein the predetermined bead configuration is at least partially defined by the toroidal support and the ejection portal relief.

15. A tire formed having an annular bead comprising an elastomeric component and at least one thread component, the tire being formed by the process comprising the steps:
a. locating a toroidal support surface;
b. placing an ejector nozzle in an interference position to the toroidal support surface;
c. placing and at least for a period of time simultaneously ejecting through the nozzle a sufficiently elongate stream of the elastomeric component in a sufficiently semi-solid state and a sufficiently elongate length of the at least one thread component disposed within the stream onto the elastomeric layer in a predetermined bead configuration.

16. A tire formed by the process according to claim 15, further comprising the step of rotating the toroidal support relative to the nozzle simultaneously with ejection of the elastomeric component and at least one thread component from the ejector nozzle.

17. A tire formed by the process according to claim 16, further comprising the step of at least partially defining the predetermined bead configuration by a relief in the nozzle at an ejection portal.

18. A tire formed by the process according to claim 17, further comprising the step of defining at least three sides of the predetermined bead configuration by at least three sides of the relief in the nozzle and at least one side by the toroidal support.

19. A tire formed by the process according to claim 18, further comprising the step of positioning the at least one thread at a preferred location within the stream simultaneously with rotation of the toroidal support and ejection of the elastomeric component and at least one thread component from the ejector nozzle.
